(19) United States
(12) Patent Application Publication
(10) Pub. No.: US 2026/0350532 A1
(43) Pub. Date: Nov. 5, 2026

(54) SYSTEM AND METHOD FOR TRACKING PLACEMENT OF TOP-STOCK HANDLING UNITS CONTAINING PRODUCT DISTRIBUTED THROUGHOUT A FACILITY

(71) Applicant: Simbe Robotics, Inc., Burlingame, CA (US)

(72) Inventors: Jariullah Safi, Burlingame, CA (US); Bradley Bogolea, Burlingame, CA (US); Tom Gehani, Burlingame, CA (US)

(21) Appl. No.: 19/651,000

(22) Filed: Apr. 17, 2026

Related U.S. Application Data
(63) Continuation-in-part of application No. 19/048,353, filed on Feb. 7, 2025.
Application No. 19/048,353 is a continuation of application No. 17/727,044, filed on Apr. 22, 2022, now Pat. No. 12,248,908.
Application No. 17/727,044 is a continuation of application No. 16/578,406, filed on Sep. 23, 2019, now Pat. No. 11,341,454.
Application No. 16/578,406 is a continuation of application No. 15/600,527, filed on May 19, 2017, now Pat. No. 10,467,587.
(60) Provisional application No. 63/790,377, filed on Apr. 17, 2025.
(60) Provisional application No. 62/339,039, filed on May 19, 2016.

(51) Int. Cl. G06Q 10/087; G05D 1/246; G05D 1/247; G06F 18/21; G06F 18/22; G06V 20/52; H04N 1/00; H04N 23/66; H04N 23/698; H04N 23/80; H04N 25/615; G05D 111/60

(52) U.S. Cl. CPC G06Q 10/087; G05D 1/246; G05D 1/247; G06F 18/21; G06F 18/22; G06Q 10/08724; G06Q 10/08778; G06V 20/52; H04N 1/00; H04N 23/66; H04N 23/698; H04N 23/80; H04N 25/615; G05D 2111/60

(57) ABSTRACT

A method includes: navigating a robotic system throughout regions of a facility to capture images of inventory structures; accessing an image of a first inventory structure; detecting an object at a first top-stock slot in a first region within the image; detecting a product identifier depicted in the first region; associating the object with a product type based on the product identifier; predicting a stock condition of the product type at the first top-stock slot based on a set of features extracted from the first region of the image; detecting absence of product at a second top-stock slot depicted in a second region of the image; generating a top-stock report specifying the first stock condition of the product type in the first top-stock slot and the absence of product stock in the second top-stock slot; and transmitting the report to an associate affiliated with the facility.

### CROSS-REFERENCE

This Application claims the benefit of U.S. Provisional Application No. 63/790,377, filed on Apr. 17, 2025, which is incorporated in its entirety by this reference.

This Application is also a Continuation-In-Part of U.S. Patent Application No. 19/048,353, filed on Feb. 7, 2025, which is a continuation application of U.S. Patent Application No. 17/727,044, filed on Apr. 22, 2022, which is a continuation application of U.S. Patent Application No. 16/578,406, filed on Sep. 23, 2019, which is a continuation application of U.S. Patent Application No. 15/600,527, filed on May 19, 2017, which claims the benefit of U.S. Provisional Application No. 62/339,039, filed on May 19, 2016, each of which is incorporated in its entirety by this reference.

### TECHNICAL FIELD

This invention relates generally to the field of stock tracking and, more specifically, to a new and useful method for tracking placement of pallets containing product within a facility in the field of stock tracking.

### BRIEF DESCRIPTION OF THE FIGURES

FIGS. 1A, 1B, and 1C are schematic representations of a method;

FIG. 2 is a schematic representation of one variation of the method;

FIG. 3 is a schematic representation of one variation of the method; and

FIG. 4 is a schematic representation of one variation of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method: Top-Stock Verification + Report

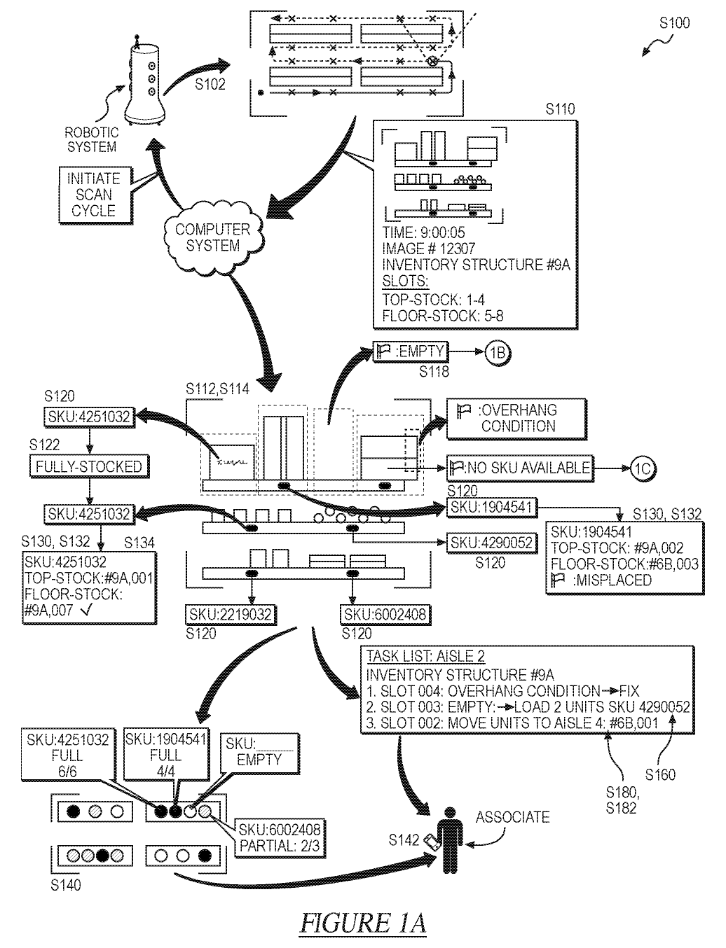

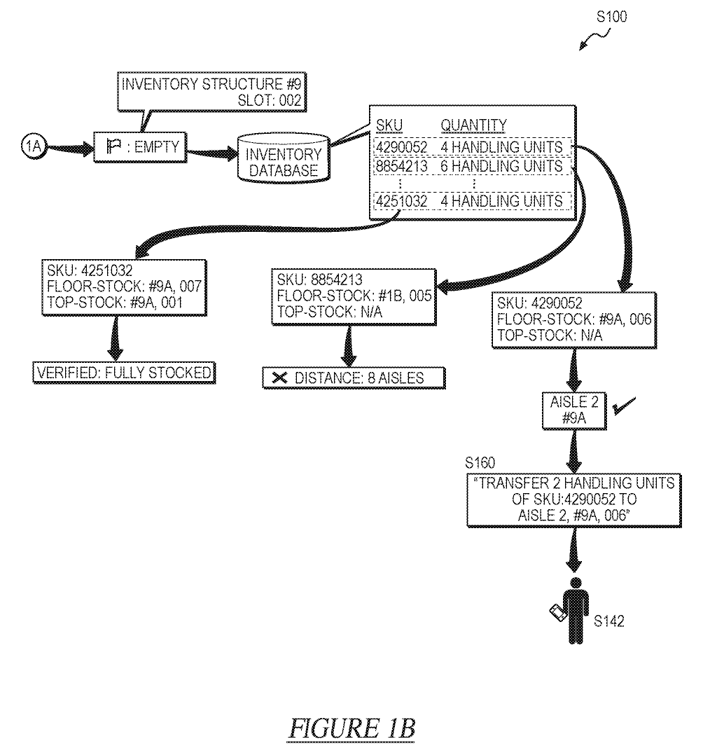

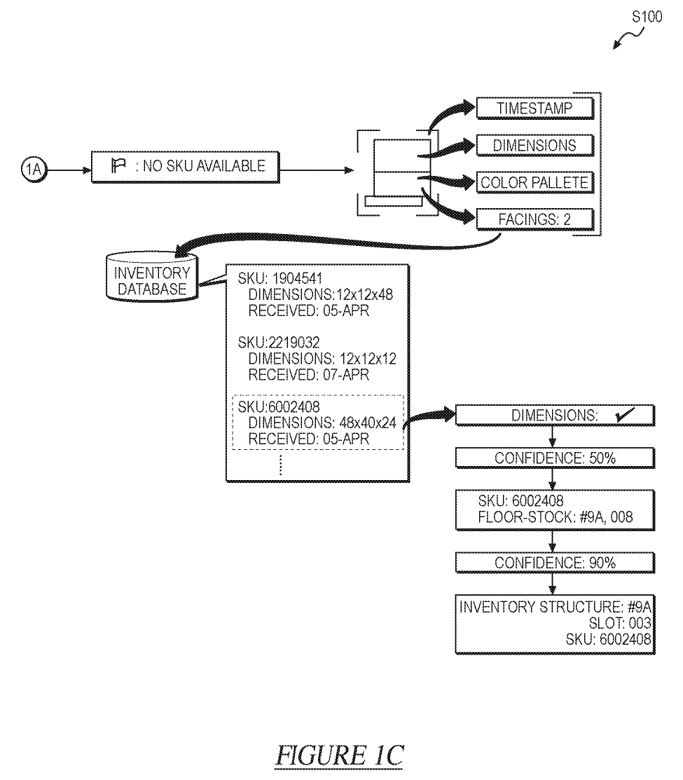

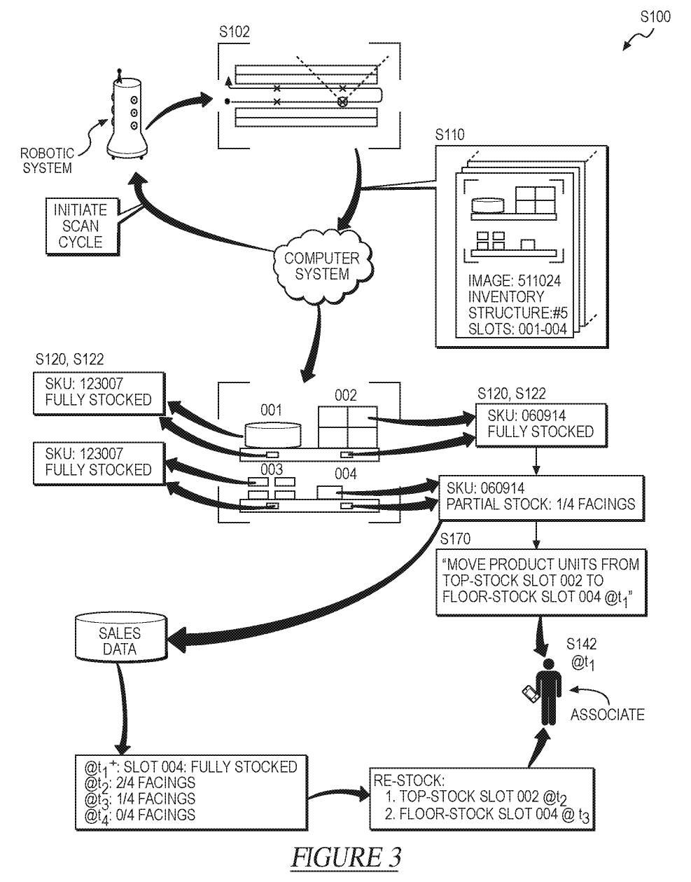

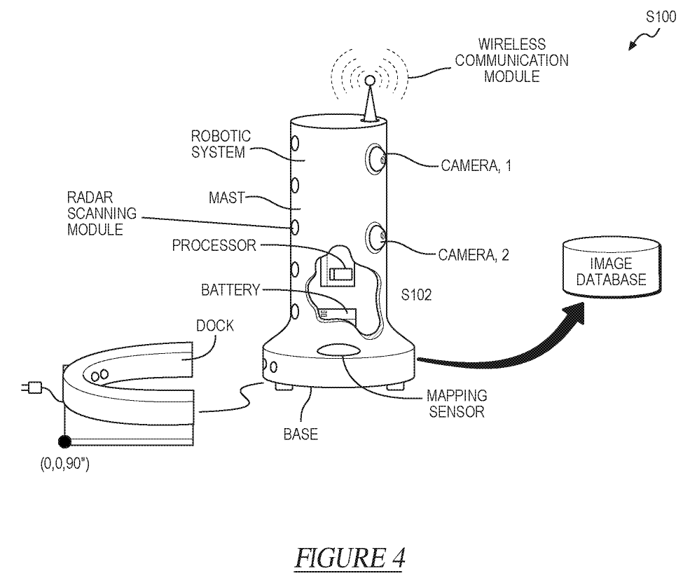

As shown in FIGS. 1A, 1B, 1C, and 2-4, a method S100 includes, at a robotic system, autonomously navigating throughout regions of a facility to capture images of inventory structures, arranged throughout the facility, via an optical sensor integrated into the robotic system in Block S102.

The method S100 further includes, at a computer system: accessing a first image of a first inventory structure captured by the robotic system at a first time in Block S110; detecting a first object in a first region of the first image, the first region corresponding to a first top-stock slot within a customer region of the facility in Block S112; detecting a first product identifier depicted in the first region of the first image in Block S114; based on the first product identifier, associating the first object with a first product type in Block S120; extracting a first set of features from the first region of the first image; based on the first set of features, predicting a first stock condition of the first product type at the first top-stock slot within the facility in Block S122; accessing a first floor-stock slot associated with the first product type in the customer region of the facility in Block S130; characterizing a location difference between the first floor-stock slot and the first top-stock slot in Block S132; and, in response to the location difference falling below a threshold difference and in response to the first stock condition corresponding to a target stock condition defined for the first product type, verifying stocking of the first product type in the customer region of the facility in Block S134.

The method S100 further includes: accessing a second image of a second inventory structure captured by the robotic system at a second time in Block S110; detecting absence of an object in a second region of the second image, the second region corresponding to a second top-stock slot within the facility in Block S118; generating a top-stock report specifying the first stock condition of the first product type at the first top-stock slot and absence of product stock at the second top-stock slot in Block S140; and transmitting the report to an associate affiliated with the facility in Block S142.

One variation of the method S100 includes: accessing a first image of a first inventory structure captured by a robotic system autonomously navigating throughout regions of a facility to capture images of inventory structures, arranged throughout the facility, via an optical sensor integrated into the robotic system in Block S110; detecting a first object in a first region of the first image, the first region corresponding to a first top-stock slot within the facility in Block S112; detecting a first product identifier depicted in the first region of the first image in Block S114; based on the first product identifier, associating the first object with a first product type in Block S120; based on features extracted from the first region of the first image, predicting a stock condition for the first product type in the first top-stock slot in Block S118; accessing a first floor-stock slot associated with the first product type in the customer region of the facility in Block S130; estimating a distance between the first floor-stock slot and the first top-stock slot in Block S132; in response to the distance falling below a threshold difference and in response to the first stock condition corresponding to a target stock condition defined for the first product type, verifying stocking of the first product type in the first top-stock slot within the customer region of the facility in Block S134; generating a top-stock report specifying presence of a set of product units of the first product type at the first top-stock slot in Block S140; and transmitting the top-stock report to an affiliate associated with the facility in Block S142.

### 1.1.1 Method: Re-Stocking Floor-Slot

In one variation, the method S100 further includes: accessing a third image of the first inventory structure captured by the robotic system at a third time in Block S110; detecting a second product identifier depicted in a second region of the third image, the second region corresponding to the first floor-stock slot in Block S112; based on the second product identifier, associating the first floor-stock slot with the first product type in Block S114; extracting a set of visual features from the second region of the third image; and estimating a quantity of product units of the first product type present in the first floor-stock slot based on the set of visual features in Block S118. In this variation, the method S100 further includes, in response to the quantity of product units falling below a threshold quantity defined for the first floor-stock slot: generating a restocking notification specifying transfer of a quantity of product units of the first product type from the first top-stock slot to the first floor-stock slot in Block S170; and transmitting the restocking notification to the associate in Block S142.

### 1.1.2 Relocating Top-Stock Based on Floor-Stock Location

In one variation, the method S100 further includes: accessing a third image of a third inventory structure captured by the robotic system at a third time in Block S110; detecting a third object in a third region of the third image, the third region corresponding to a third top-stock slot within the customer region of the facility in Block S112; detecting a third product identifier depicted in the third region of the third image in Block S114; based on the third product identifier, associating the third object with a third product type in Block S120; extracting a third set of features from the third region of the third image; based on the third set of features, predicting a third stock condition of the third product type at the third top-stock slot within the facility in Block S118; accessing a third floor-stock slot associated with the third product type in the customer region of the facility in Block S130; and calculating a third location difference between the third floor-stock slot and the third top-stock slot in Block S132. In this variation, the method S100 further includes, in response to the third location difference exceeding a third threshold location difference defined for the third product type: flagging the third object for relocation to a fourth top-stock slot falling within the third threshold difference of the third floor-stock slot in Block S180; generating a prompt to relocate the third object from the third top-stock slot to the fourth top-stock slot in Block S182; and transmitting the prompt to the associate in Block S142.

### 1.2 Method: Assigning Top-Stock Slots

One variation of the method S100 includes, at a robotic system, autonomously navigating throughout regions of a facility to capture images of inventory structures, arranged throughout the facility, via an optical sensor integrated into the robotic system in Block S102.

In this variation, the method S100 further includes, at a computer system: accessing a first image of a first inventory structure captured by the robotic system at a first time in Block S110; detecting a first object in a first region of the first image, the first region in the first image corresponding to a first top-stock slot within a customer region of the facility in Block S112; detecting a first product identifier depicted in the first region of the first image in Block S114; based on the first product identifier, associating the first object with a first product type in Block S120; accessing a second image of a second inventory structure captured by the robotic system at a second time in Block S110; detecting absence of an object in a second region of the second image, the second region corresponding to a second top-stock slot within the customer region of the facility in Block S118; and generating a top-stock map depicting stock conditions of top-stock slots throughout the facility, the map depicting the first object associated with the first product type occupying the first top-stock slot and absence of product stock in the second top-stock slot in Block S140.

The method S100 further includes: receiving confirmation of presence of a set of product units of a second product type in an inventory region of the facility in Block S150; accessing a floor-stock slot, in the customer region of the facility, assigned to the second product type in Block S130; based on the floor-stock slot, assigning the second top-stock slot to the set of product units of the second product type in Block S152; generating a prompt to transfer the set of product units of the second product type from the inventory region to the second top-stock slot in Block S160; and transmitting the top-stock map and the prompt to an associate affiliated with the facility in Block S142.

### 1.3 Method: Full Pallet

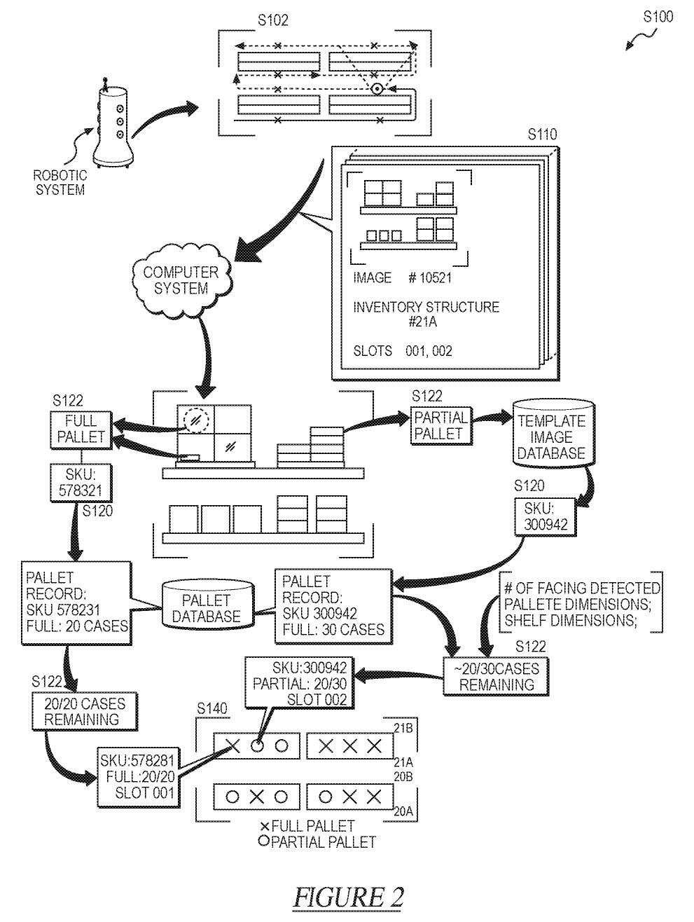

As shown in FIG. 2, one variation of the method S100 for tracking and maintaining inventory of pallets and corresponding product includes: accessing a first image of a first inventory structure in a facility, the first image captured by a robotic system traversing the facility during a scanning period; detecting a first object – corresponding to a first pallet – in a first region of the first image; extracting a first set of features from the first region of the first image; based on the first set of features, detecting presence of enclosure wrap applied to the first pallet; in response to detecting presence of enclosure wrap applied to the first pallet, labeling the first pallet as a full pallet (or “unopened” pallet); and, based on the first set of features, identifying a first product type of product units stored within the first pallet. The method S100 further includes, in response to labeling the first pallet as a full pallet: accessing an inventory record generated for the facility and specifying a set of pallets received at the facility during a preceding time period; searching the inventory record for the first pallet containing product units of the first product type; accessing a target quantity of product units of the first product type corresponding to a full pallet for the first product type; and predicting a first quantity of product units of the first product type – corresponding to the target quantity – stored within the first pallet.

The method S100 further includes: generating a top-stock report indicating a location of the first pallet within the facility, the first product type of product units stored within the first pallet, and a prediction of the first pallet as a full pallet including the first quantity of product units of the first product type; and serving the top-stock report to an associate affiliated with the facility.

### 1.4 Method: Partial Pallet

As shown in FIG. 2, one variation of the method S100 for tracking and maintaining inventory of pallets and corresponding product includes: accessing a first image of a first inventory structure in a facility, the first image captured by a robotic system traversing the facility during a scanning period; detecting a first object – corresponding to a first pallet – in a first region of the first image; extracting a first set of features from the first region of the first image; based on the first set of features, detecting absence of enclosure wrap applied to the first pallet; in response to detecting absence of enclosure wrap applied to the first pallet, labeling the first pallet as a partial pallet (or “opened” pallet); and, based on the first set of features, identifying a first product type of product units stored within the first pallet. In this variation, the method S100 further includes, in response to labeling the first pallet as a partial pallet: detecting a quantity of facings on the first pallet and depicted in the first image; accessing a set of fixed dimensions (e.g., length, width, depth) of the first inventory structure; and, based on the quantity of facings and the set of fixed dimensions, predicting a quantity of product units of the first product type stored within the first pallet.

In this variation, the method S100 further includes: generating a top-stock report indicating a location of the first pallet within the facility, the first product type of product units stored within the first pallet, and a prediction of the first pallet as a partial pallet including the first quantity of product units of the first product type; and serving the top-stock report to an associate affiliated with the facility.

### 2. Applications

Generally, Blocks of the method S100 can be executed by a computer system: to dispatch a robotic system to capture images of products arranged on shelves throughout a facility (e.g., a hardware store, a warehouse); to detect pallets containing product on shelves in inventory structures throughout the facility based on images captured by the robotic system, such as on top shelves of these inventory structures (e.g., above floor stock) in a customer-facing region of the facility and/or in shelves of inventory structures in a back-of-store inventory region inaccessible to customers; to identify product types of product units stored within these detected pallets; to generate a top-stock report indicating locations and product types associated with detected pallets throughout the facility; and to serve this top-stock report to an associate affiliated with the facility to selectively access these pallets for re-stocking various product types throughout the facility and/or for maintaining a high-resolution record of all stock throughout the facility.

In particular, the computer system can leverage insights derived from images of inventory structures – captured by the robotic system – to generate a top-stock report indicating: detection of a set of pallets – in images captured by the robotic system – within the facility; a location of each pallet, in the set of pallets, within the facility, such as within a particular slot of a top shelf of an inventory structure (e.g., above floor stock) within a customer-facing region of the facility and/or within a particular slot of an inventory structure in a back-of-store inventory region of the facility; one or more product types of product units loaded in each pallet in the set of pallets; whether each pallet, in the set of pallets, is a full pallet – fully stocked with product units and/or including enclosure wrap (e.g., stretch wrap, pallet wrap) arranged about the pallet – or a partial pallet partially stocked with product units and/or omitting enclosure wrap; whether each pallet, in the set of pallets, is a homogenous pallet – corresponding to a single product type – or a mixed pallet corresponding to multiple product types; a predicted quantity of product units remaining within each pallet in the set of pallets; etc.

In one example, the computer system generates a top-stock map depicting locations of each pallet distributed within the facility. The computer system can then annotate the top-stock map with pallet-specific information, such as including: a particular product type assigned to a pallet; a quantity of product units assigned to the pallet and/or remaining in the pallet; a pallet type of the pallet, such as a full pallet, a partial pallet, a homogenous pallet, a mixed pallet; etc. The computer system can then serve this top-stock map to an affiliate of the facility to enable locating of product units of product types contained in these pallets throughout the facility and/or rapid re-stocking of product types in customer-facing slots within the store with product units contained in these pallets.

In one implementation, the computer system triggers the robotic system to: autonomously traverse an aisle of the store in the customer-facing region of the store; and to capture a set of images of stock arranged on a top shelf of each inventory structure lining the aisle in order to enable detection of pallets stored on top shelves of inventory structures – above floor stock of products accessible to customers – on both sides of the aisle. The computer system can then: “flatten” these images in preparation for detecting and extracting features from the set of images; and/or assemble the set of images into a panoramic image in preparation for detecting and extracting features from this panoramic image. Furthermore, the computer system can: detect presence of a pallet depicted in an image captured by the robotic system; and predict the pallet as a “full” pallet or a “partial” pallet based on features extracted from the image and corresponding to the pallet. For example, the computer system can: extract a set of features from a region of the image corresponding to the pallet; based on the set of features, detect presence of enclosure wrap applied to the pallet depicted in the image; and, in response to detecting presence of enclosure wrap, interpret the pallet as a full pallet (e.g., an unopened and/or fully-stocked pallet). Alternatively, in response to detecting absence of enclosure wrap based on the set of features extracted from the region of the image, the computer system can interpret the pallet as a partial pallet (e.g., an opened and/or partially-stocked pallet).

The computer system can thus generate a top-stock report – such as in the form of a top-stock map (e.g., as described above) – indicating locations of all full pallets and partial pallets distributed throughout the facility.

### 2.1 Applications: Placement Guidance

Generally, the computer system can leverage the top-stock report to guide associates in restocking product throughout the facility. In particular, the computer system can: access the top-stock map – annotating top-stock slots exhibiting empty stock conditions and top-stock slots occupied by detected handling units (e.g., pallets, boxes, individual product units) – generated for the facility; receive confirmation of presence of a set of product units of a particular product type in an inventory region of the facility; identify a floor-stock slot, in the customer region of the facility, assigned to the particular product type; and, based on proximity between available top-stock slots and the floor-stock slot, assign a top-stock slot to the set of product units. The computer system can then generate a prompt to transfer the set of product units from the inventory region to the assigned top-stock slot and transmit the prompt to an associate.

The computer system can thus minimize travel distance for the associate by assigning a top-stock slot in close proximity to the floor-stock slot associated with the product type, thereby reducing the time required to restock product from the top-stock slot to the floor-stock shelf below.

In one implementation, the computer system can: assign placement of a set of incoming handling units (e.g., pallets) to a set of top-stock slots throughout the facility based on proximity of these top-stock slots to floor-stock slots assigned to corresponding product types, while additionally constraining placement of handling units in order to reduce handling complexity and labor associated with transferring these handling units. In particular, the computer system can: access a set of incoming handling units received at the facility, each handling unit corresponding to a product type; access a top-stock map identifying a set of candidate top-stock slots – within a customer-facing region of the facility – within the facility that are empty or partially empty; and identify, for each product type, a corresponding floor-stock slot assigned to the product type within the customer-facing region of the facility. The computer system can then: for each candidate top-stock slot, calculate a distance between the candidate top-stock slot and the corresponding floor-stock slot assigned to the product type; and identify a subset of candidate top-stock slots exhibiting distances – between the top-stock slot and the floor-stock slot – falling below a threshold distance.

The computer system can further: access a set of placement constraints associated with storing handling units in the facility, such as including accessibility of a top-stock slot, presence of obstructions adjacent the top-stock slot, availability of contiguous space for placement of a handling unit, and/or a number of repositioning operations required to clear the top-stock slot; and filter the subset of candidate top-stock slots based on the set of placement constraints to identify a reduced set of candidate top-stock slots predicted to minimize handling time and effort. The computer system can then: select a target top-stock slot from the reduced set of candidate top-stock slots; generate a re-stocking notification assigning the handling unit to the target top-stock slot; and transmit the re-stocking notification to an associate within the facility.

Furthermore, the computer system can access a current task assignment defined for the associate, identify additional top-stock slots within the same aisle that have empty or partially-stocked conditions, and generate a batched restocking task list specifying the assigned top-stock slot and the additional top-stock slots within the same aisle, thereby enabling the associate to complete multiple restocking tasks in a single pass through the aisle.

### 2.2 Re-Stocking of Floor-Stock Slots

In another implementation, the computer system can: access an image of a first floor-stock slot assigned to a first product type, the image captured by the robotic system within a customer-facing region of the facility; extract a set of visual features from a region of the image corresponding to the first floor-stock slot; and estimate a quantity of product units of the first product type present in the first floor-stock slot based on the set of visual features. Then, in response to the quantity of product units falling below a threshold quantity defined for the first floor-stock slot, the computer system can: identify a first top-stock slot assigned to the first product type within the facility; generate a restocking notification specifying transfer of a quantity of product units of the first product type from the first top-stock slot to the first floor-stock slot; and transmit the restocking notification to a computing device associated with an associate prior to depletion of the first floor-stock slot.

Additionally, the computer system can: access a set of sales data specifying an historical sales rate of the first product type at the floor-stock slot within the customer region of the facility; predict an out-of-stock condition at the floor-stock slot at a future time based on the set of sales data; and generate and transmit a restocking notification to the associate prior to the predicted out-of-stock time, thereby enabling proactive replenishment before the out-of-stock condition occurs at the floor-stock slot accessible to customers. The computer system can thus transmit a restocking notification to the associate prior to a predicted out-of-stock condition at floor-stock slots, thereby enabling proactive replenishment before an out-of-stock condition occurs.

Furthermore, in one variation, the computer system can: estimate a rate of depletion of product units from the first floor-stock slot based on a sequence of images captured by the robotic system over time; and adjust the quantity of product units specified in the restocking notification based on the estimated rate of depletion. For example, the computer system can: detect a first quantity of product units in the first floor-stock slot at a first time; detect a second quantity of product units in the first floor-stock slot at a second time succeeding the first time; calculate a rate of change between the first quantity and the second quantity; and, in response to the rate of change exceeding a threshold rate, increase a quantity of product units specified in the restocking notification.

Therefore, the computer system can proactively initiate transfer of product units from top-stock slots to floor-stock slots based on detected low-inventory conditions at the shelf, thereby reducing likelihood of out-of-stock events and improving on-shelf availability of product units within the facility.

Furthermore, the computer system can: receive a shipment manifest identifying an upcoming delivery of product units to the facility; and, in response to the shipment manifest indicating delivery of a product type associated with an empty top-stock slot, generate a re-stocking notification for the associate prior to arrival of the shipment, thereby enabling the associate to immediately transfer the incoming product units directly to the correct top-stock slot upon arrival.

### 3. Terms

A “store” is referred to herein as a (static or mobile) facility containing one or more inventory structures.

A “product” is referred to herein as a type of loose or packaged good associated with a particular product identifier (e.g., a SKU) and representing a particular class, type, and varietal.

A “unit” or “product unit” is referred to herein as an instance of a product – such as one bottle of detergent, one box of cereal, or package of bottled water – associated with one SKU value.

A “product facing” is referred to herein as a side of a product designated for a slot.

A “slot” is referred to herein as a section (or a “bin”) of a shelf on an “inventory structure” designated for storing and displaying product units of the product type (i.e., of the identical SKU or CPU). An inventory structure can include a shelving segment, a shelving structure, or other product display containing one or more slots on one or more shelves.

A “planogram” is referred to herein as a plan or layout designating display and stocking of multiple product facings across multiple slots, such as: in a particular shelving segment; across a particular shelving structure; across multiple shelving structures within a particular aisle; across multiple aisles in the store; or throughout the entirety of the store. In particular, the planogram can specify a target product type, a target product placement, a target product quantity, a target product quality (e.g., ripeness, time to peak ripeness, maximum bruising), and/or a target product orientation for a fully-stocked slot for each slot represented in the planogram. For example, the planogram can define a graphical representation of an inventory structure in the store, including graphical representations of each slot in this inventory structure, each populated with a quantity of graphical representations of product type assigned to this slot equal to a quantity of product facings assigned to this slot. Alternatively, the planogram can record textual product placement for one or more inventory structures in the store in the form of a spreadsheet, slot index, or other database.

Furthermore, a “realogram” is referred to herein as a representation of the actual products, actual product placement, actual product quantity, and actual product orientation of products and product units throughout the store during a scan cycle, such as derived by the computer system according to Blocks of the method S100 based on photographic images and/or other data recorded by the robotic system while autonomously executing scan cycles in the store.

A “slot map” is referred to herein as a representation of a layout of a set of inventory structures within the store in a 2D vectorized grid that, for each inventory structure, designates horizontal shelf facings on the inventory structure, vertical gaps between shelving segments of the inventory structure, and individual slots containing product units on the inventory structure. The computer system can initialize the slot map (e.g., when onboarding a new store that does not have or use a planogram for the store) and populate the slot map based on images captured by a robotic system autonomously navigating the store during an initial scan cycle.

A “scene” is referred to herein as a grouping of a set of slots on inventory structures within the store based on a set of common product labels (e.g., a product category, a product attribute such as gluten-free and/or vegan, and/or a promotional status) associated with the product units arranged in the slots and/or a common fixture type between the slots. The computer system can segment all of the slots within the store into different scenes and, for each slot, annotate the slot map with a slot location, product labels for the product units arranged within the slot, and scene labels associated with the slot. Furthermore, a slot can belong to more than one scene (e.g., a slot can be part of “face wash” scene, a subcategory of the “makeup/beauty” scene, and the “2-for-1 promotion” scene).

A "handling unit" is referred to herein as a discrete unit load of product that is placed, stored, and retrieved as a single entity within a facility. For example, a handling unit can be a pallet, a slip sheet, a layer board, a case pack, a box, or any other carrier on or in which one or more product units are arranged. Generally, a handling unit exhibits a defined footprint and is associated with a particular product type or SKU.

A “top-stock slot” or “top-stock location” is referred to herein as a slot or location within the customer region of the facility designated for storing reserve product units above the customer-accessible floor-stock shelf, such as on a top shelf or overhead storage area of an inventory structure. For example, a top-stock slot can be occupied by a pallet (or other handling unit type) – loaded with a set of product units – or can be empty, indicating an absence of reserve stock at that top-stock slot.

A “floor-stock slot” or “floor-stock location” is referred to herein as a slot or location within the customer region of the facility designated for displaying product units that are directly accessible to customers, such as on a standard shelf of an inventory structure below a top-stock slot. For example, a floor-stock slot can be occupied by a quantity of product units of a particular product type available for purchase by a customer.

An “associate” is referred to herein as a person employed by or affiliated with the facility. For example, an associate may be responsible for restocking, inventory management, or other operational tasks within the facility, including receiving, staging, and transferring product units between inventory regions and customer-facing regions of the facility.

The method S100 is described herein as executed by a computer system (e.g., a remote server, a computer network) remote from the robotic system. However, Blocks of the method S100 can be executed locally by one or more robotic systems deployed in a retail space (or store, warehouse, etc.), by a local computer system (e.g., a local server), or by any other computer system.

Furthermore, Blocks of the method S100 are described below as executed by the computer system to identify products, shelf tags, and promotional tags on open shelves in shelving structures within a grocery store. However, the computer system can implement similar methods and techniques to identify products, shelf tags, and promotional tags on cubbies, in a refrigeration unit, on a wall rack, on a freestanding floor rack, on a table, on a hot-food display, or on or in any other product organizer, display, or other inventory structure in a retail space.

### 4. Mobile Robotic System

A robotic system autonomously navigates throughout a store and records images – such as color (e.g., RGB) images of packaged goods and hyper-spectral images of fresh produce and other perishable goods – continuously or at discrete predefined waypoints throughout the store during a scan cycle. Generally, the robotic system can define a network-enabled mobile robot that can autonomously: traverse a store; capture color and/or hyper-spectral images of inventory structure, shelves, produce displays, etc. within the store; and upload those images to the computer system for analysis, as described below.

In one implementation, the robotic system defines an autonomous imaging vehicle including: a base; a drive system (e.g., a pair of two driven wheels and two swiveling castors) arranged in the base; a power supply (e.g., an electric battery); a set of mapping sensors (e.g., fore and aft scanning LIDAR systems); a processor that transforms data collected by the mapping sensors into two- or three-dimensional maps of a space around the robotic system; a mast extending vertically from the base; a set of color cameras arranged on the mast; one or more hyper-spectral sensors (or “cameras,” “imagers”) arranged on the mast and configured to record hyper-spectral images representing intensities of electromagnetic radiation within and outside of the visible spectrum; and a wireless communication module that downloads waypoints and a master map of a store from a computer system (e.g., a remote server) and that uploads photographic images captured by the camera and maps generated by the processor to the computer system. In this implementation, the robotic system can include cameras and hyper-spectral sensors mounted statically to the mast, such as two vertically offset cameras and hyper-spectral sensors on a left side of the mast and two vertically offset cameras and hyper-spectral sensors on the right side of mast. The robotic system can additionally or alternatively include articulable cameras and hyper-spectral sensors, such as: one camera and hyper-spectral sensor on the left side of the mast and supported by a first vertical scanning actuator; and one camera and hyper-spectral sensor on the right side of the mast and supported by a second vertical scanning actuator. The robotic system can also include a zoom lens, a wide-angle lens, or any other type of lens on each camera and/or hyper-spectral sensor.

For example, the robotic system can include a zoom lens on each camera, in the set of cameras, installed on the mast, in order to enable detection of objects (e.g., products, pallets, tags, barcodes) at varying heights of inventory structures within a facility. In particular, the robotic system can include the set of cameras, each camera defining a set of camera characteristics, such as including: a camera type, a zoom level of a zoom lens integrated with the camera; a camera position and/or camera angle on the mast; etc. The robotic system can define this particular set of camera characteristics in order to enable capturing of images – at a target resolution – of a top shelf and/or a pallet rack at a target height.

In one variation described below, the robotic system further includes a wireless energy/wireless charging subsystem configured to broadcast a signal toward a fixed camera installed in the store in order to recharge this fixed camera. However, the robotic system can define any other form and can include any other subsystems or elements supporting autonomous navigating and image capture throughout a store environment.

Furthermore, multiple robotic systems can be deployed in a single store and can be configured to cooperate to image shelves within the store. For example, two robotic systems can be placed in a large single-floor retail store and can cooperate to collect images of all shelves and produce displays in the store within a threshold period of time (e.g., within one hour). In another example, one robotic system can be placed on each floor of a multi-floor store, and each robotic system can each collect images of shelves and produce displays on its corresponding floor. The computer system can then aggregate color and/or hyper-spectral images captured by multiple robotic systems placed in one store to generate a graph, map, table, and/or task list for managing distribution and maintenance of product throughout the store.

### 5. Scan Cycle

In particular, the computer system dispatches the mobile robotic system (hereinafter the “robotic system”) to: autonomously navigate throughout regions of the store, such as including a customer-facing region (or “front”) of the store; and to image inventory structures in the front of the store.

For example, inventory structures in the front of the store can include: store shelves; aisle end caps; produce bins; and other structures from which a patron can select a product type. Inventory structures located in the front of the store can also include “top-shelf” inventory locations, such as non-customer-product facing shelves located overhead customer-product facing slots and configured to store excess and loose product units not returned to the back of the store after re-stocking of the customer-product facing slots below. Inventory structures in the back of the store can include structures or areas designated to hold product delivered to the store – such as stored in boxed formats – before these product units are transferred to the front of the store during later re-stocking periods. For example, back-of-store inventory structures can include shelving, bins, floor spaces, and receiving areas.

In one implementation, during a scan cycle, the robotic system can: autonomously navigate to an inventory structure in the front of the store; record an image of the customer-product facing inventory structure via an optical sensor integrated in the robotic system; upload the image to a database; and repeat this process to image each other customer-product facing inventory structure in the front of the store during the scan cycle.

Additionally or alternatively, in one implementation, the robotic system can: autonomously navigate to an inventory structure in the front of the store; record a sequence of photographic images of the customer-product facing inventory structure via the optical sensor while traversing an aisle in the store facing the first inventory structure; and upload the sequence of images to a database. The computer system can then: access the sequence of photographic images captured by the optical sensor in the robotic system during the first scan cycle; and compile the sequence of photographic images into an image (e.g., a singular image) defining a first composite photographic image depicting a set of shelving segments spanning the inventory structure.

The computer system can then retrieve a first image captured by the computer system during this scan cycle and implement computer vision techniques described below and in U.S. Patent Application No. 15/600,527, filed on May 19, 2017, which is incorporated in its entirety by this reference: to detect regions of the image depicting individual slots (e.g., based on positions of shelf tags detected in the image, based on positions of product units detected in the image, or based on slot location defined in a planogram); to retrieve template visual features of known product types assigned to these slots (e.g., according to shelf tags or the planogram); to extract features from these regions of the image; to detect and identify product units in these slots based on congruence of features extracted from corresponding regions of the image and template visual features representing these known product types; and to compile locations and product types of these product units into stock conditions of each slot detected in the image.

### 5.1 Scan Pathway

Generally, the computer system triggers the robotic system to: autonomously traverse an aisle of the store in the customer-facing region of the store; and to capture images of stock arranged on a top shelf of each inventory structure lining the aisle.

In particular, the computer system can: trigger the robotic system to autonomously traverse an aisle in the customer-facing region of the store; trigger the robotic system to capture a first image of a first top shelf – loaded with a first set of pallets loaded with product – of a first inventory structure arranged on a first side of the aisle; and trigger the robotic system to capture a second image of a second top shelf – loaded with a second set of pallets loaded with product – of a second inventory structure arranged on a second side of the aisle opposite the first side.

In one implementation, in order to enable capturing of images of top shelves of inventory structures, the computer system can trigger the robotic system to traverse a particular pathway through an aisle configured to reduce a viewing angle of an optical sensor – installed on the robotic system – relative a top shelf of an inventory structure.

For example, during a first time period, the computer system can: trigger the robotic system to traverse a first pathway extending along a first side of the aisle adjacent a first inventory structure; and, while traversing the first pathway, trigger the robotic system to capture a first image of a first top shelf of a second inventory structure opposite the first inventory structure in the aisle. By triggering the robotic system to traverse the first pathway – contiguous the first inventory structure – while capturing the first image of the first top shelf of the second inventory structure, the computer system can maximize a distance between the robotic system and the second inventory structure and therefore minimize the viewing angle between the optical sensor and the first top shelf of the second inventory structure. Then, during a second time period succeeding the first time period, the computer system can: trigger the robotic system to traverse a second pathway extending along a second side of the aisle – opposite the first side of the aisle – adjacent a second inventory structure; and, while traversing the second pathway, trigger the robotic system to capture a second image of a second top shelf of the first inventory structure. Therefore, the computer system can similarly maximize a distance between the robotic system and the first inventory structure and minimize the viewing angle between the optical sensor and the second top shelf of the first inventory structure.

### 5.2 Stitched Image Generation

Upon retrieval of an image captured by the robotic system, the computer system can “dewarp,” “flatten,” or otherwise preprocess the image in preparation for detecting and extracting features from the image.

In particular, the computer system can: access images – captured by cameras offset vertically along the mast of the robotic system and defining a viewing angle from each camera to pallets and/or product on shelves – of inventory structures of varying heights (e.g., 5 feet, 50 feet) loaded with pallets and/or floor stock of products at a height within these inventory structures; and flatten these images in order to correct for distortions based on the viewing angle of each camera, thereby enabling capture of images of inventory structures at any height while enabling detection of objects (e.g., pallets, products) within these images. For example, the computer system can: access an image – depicting an inventory structure loaded with a pallet at a first height on the inventory structure – captured by a first camera integrated within the mast at a second height falling below the first height; access a set of capture data – such as including a distance from the first camera and the pallet depicted in the image (e.g., output by a LIDAR sensor integrated within the robotic system) – associated with the image; and leverage the set of capture data and the image to generate a “flattened” image depicting the inventory structure from a viewing position at the first height.

In one implementation, the computer system can stitch images – recorded by cameras offset vertically along the mast of the robotic system and recorded along a sequence of adjacent waypoints along a particular inventory structure – into a single panoramic image of the particular inventory structure. The computer system can then segment the panoramic image into discrete regions, where each region corresponds to one shelving segment, one shelf, or one slot within the particular inventory structure, such as according to methods and techniques described below.

The computer system can also implement computer vision techniques (e.g., object recognition, edge detection, optical character recognition) to identify a perimeter or a boundary of each product unit within the product region; and then crop the image around each product unit such that only features corresponding to the product unit are extracted from the image and processed.

In one variation, the computer system can: crop an image around an area or volume above a shelf corresponding to a discrete object – in a set of discrete objects – shown in a position on the shelf in the image; and repeat this process for other discrete objects detected in the image to generate a set of discrete image boundaries, each boundary representing one discrete object arranged in a unique location on the shelf.

However, the computer system can access images of any other type and segment these images in any other way.

### 6. Pallet Detection

Generally, the computer system can detect presence of a pallet in an image captured by the robotic system.

For example, the computer system can extract features from an image(s) captured by the robotic system to: detect one or more pallets stored on a top shelf of an inventory structure arranged within a customer-facing region of the facility, such as above product units of retail floor stock arranged on shelves of the inventory structure below the top shelf; and/or detect one or more pallets stored on an inventory structure arranged within a back-of-store inventory region of the facility (e.g., inaccessible to customers).

In particular, the computer system can: access an image of an inventory structure captured by the robotic system while navigating through the facility, such as through a customer-facing region of the facility and/or in a back-of-store inventory region of the facility; detect a first set of objects in a first region of the image; and, based on features of the first set of objects, detect a first pallet – loaded with product units of a first product type – depicted in the image in the first region. Furthermore, the computer system can: detect a second set of objects in a second region of the image; and, based on features of the second set of objects, detect a second pallet – loaded with product units of a second product type – depicted in the image in the second region. The computer system can thus repeat this process to detect each pallet occupying the inventory structure depicted in the image.

In one implementation, the computer system can: detect presence of a pallet depicted in the image captured by the robotic system; and predict the pallet as a “full” pallet or a “partial” pallet based on features extracted from the image and corresponding to the pallet. For example, the computer system can: access a first image of a first inventory structure captured by the robotic system while navigating through the facility; detect a first object – corresponding to a first pallet – within a first region of the first image; extract a first set of features from the first region of the first image; and, based on the first set of features, detect presence of enclosure wrap applied to the first pallet depicted in the first image. Based on detection of enclosure wrap applied to the first pallet, the computer system can interpret the first pallet as a full pallet (e.g., an unopened and/or fully-stocked pallet).

Additionally, in another example, the computer system can: access a second image of a second inventory structure captured by the robotic system while navigating through the facility; detect a second object – corresponding to a second pallet – within a second region of the second image; extract a second set of features from the second region of the second image; and, based on the second set of features, detect absence of enclosure wrap applied to the second pallet depicted in the second image. In response to detecting absence of enclosure wrap applied to the second pallet, the computer system can interpret the second pallet as a partial pallet (e.g., an opened and/or partially-stocked pallet).

### 6.1 Product Type

Generally, the computer system can identify a product type of product units within a pallet stored on an inventory structure in the facility.

### 6.1.1 Template Product Images

In one implementation, the computer system can leverage images – captured by the robotic system – of a product unit(s) in the pallet and template images of product units of each product type, defined for the facility, to identify a particular product type of the product unit(s) depicted in the image and stored in the pallet.

For example, for a partial pallet excluding enclosure wrap – and therefore loaded with product units more clearly visible or unobscured by enclosure wrap – the computer system can: access an image of an inventory structure containing the partial pallet; detect a set of objects – corresponding to product units – in a region of the image corresponding to the partial pallet; search template images in a template image database to identify a particular template image corresponding to (e.g., matching) the set of objects depicted in the image; identify a product type assigned to the particular template image corresponding to the set of objects; and interpret presence of product units of the product type within the partial pallet depicted in the image. In this example, the computer system can, therefore, leverage absence of enclosure wrap about the partial pallet to identify a product type of product units within the partial pallet based on matching of features extracted from the image to features of the particular template image.

### 6.1.2 Product Identifier on Handling Unit

Additionally, or alternatively, in another implementation, the computer system can leverage an identifier affixed to the pallet to identify a particular product type of the product unit(s) depicted in the image and stored in the pallet. For example, for a full pallet including enclosure wrap – and therefore loaded with product units less clearly visible in the image or obscured by enclosure wrap – the computer system can: access an image of an inventory structure containing the full pallet; detect an identifier (e.g., a barcode, a descriptor) affixed directly to the pallet and/or to the enclosure wrap applied to the pallet; access a product database defined for the facility; search the product database for the identifier; and identify a particular product type, in a set of product types, assigned to the identifier in the product database. The computer system can thus interpret presence of product units of the particular product type within this full pallet. In this example, the computer system can, therefore, leverage detection of the identifier – affixed to the pallet and/or to the enclosure wrap – to identify a product type of product units loaded within the pallet, regardless of visibility of these product units in the image or images captured by the robotic system.

### 6.1.3 Inventory Record

Additionally or alternatively, in another implementation, the computer system can leverage an inventory record – generated for the facility – to predict a particular product type of product units loaded within a particular pallet.

In particular, as shown in FIG. 1C, the computer system can: detect an object (e.g., a handling unit) – with no visible product identifier – in an image captured by the robotic system at a first time; extract a set of features – such as including a form factor, a wrap color, a surface texture of the handling unit, etc. – from a region of the image depicting the handling unit and corresponding to a first top-stock slot within the facility; access an inventory record specifying a set of handling units – each handling unit, in the set of handling units, associated with a particular product type and a time of receipt – received at the facility during a preceding time period; and associate the object with a particular product type based on the set of features, the first time, and the first top-stock slot.

For example, the computer system can: identify a first subset of handling units, in the set of handling units, associated with receipt times preceding the first time by less than a threshold duration; identify a second subset of handling units, in the first subset of handling units, exhibiting features similar to the set of features extracted from the image; identify a third subset of handling units, in the second subset of handling units, associated with product types located in floor-stock slots within a threshold distance of the first top-stock slot; and predict the object as corresponding to a first handling unit, in the third subset of handling units, associated with a particular product type. The computer system can thus assign the particular product type to the detected object of the matching inventory record entry based on temporal and spatial proximity to the first top-stock slot. Therefore, the computer system can infer a product type of product units within the handling unit in the absence of any directly-readable product identifier and/or without detection of visible product units within the object.

For example, for a full pallet including enclosure wrap – and therefore loaded with product units less clearly visible in the image or obscured by enclosure wrap – the computer system can: access an image of an inventory structure containing the full pallet; detect presence of enclosure wrap applied to the pallet; detect absence of an identifier or identifying information on the pallet and/or on the enclosure wrap applied to the pallet; access an inventory record – corresponding to a list of pallet shipments received at the facility during a preceding time period – generated for the facility; and match the pallet to a particular pallet – assigned to a particular product type – received at the facility based on characteristics of the particular pallet detailed in the inventory record. In particular, in one example, the computer system can: access a first timestamp corresponding to capture of the image by the robotic system; access a second timestamp – recorded in the inventory record – corresponding to receipt of the particular pallet at the facility; and, based on the first timestamp and the second timestamp, predict that the pallet stored in the inventory structure (and detected in the image) corresponds to this particular pallet in the inventory record.

### 6.1.4 Floor-Stock Product Type

Additionally or alternatively, in another implementation, the computer system can identify a product type of a first object at a first top-stock slot based on a product identifier depicted in a shelf label affixed to the first inventory structure below the first top-stock slot.

In particular, the computer system can: detect a shelf label depicted in a region of the image below the first region corresponding to the first top-stock slot; extract a SKU, UPC, or other product identifier depicted on the shelf label; and, based on the product identifier, associate the first object with the first product type assigned to the shelf label. Therefore, the computer system can leverage spatial correlation between the first top-stock slot and the floor-stock slot – arranged directly below the first top-stock slot– to predict the product type of the first object at the first top-stock slot, without requiring detection of a visible identifier arranged on the object and/or at the first top-stock slot.

### 6.1.5 Mixed Pallet Types

In one variation, the computer system can identify multiple product types of product units within a single pallet stored on an inventory structure in the facility.

In particular, in this variation, the computer system can leverage images – captured by the robotic system – of product units in the pallet and template images of product units of each product type, defined for the facility, to identify a set of product types of product unit depicted in the image and stored in the pallet. In this variation, the computer system can, therefore, identify whether a particular pallet is a homogenous pallet – containing product units of a single product type – or a mixed pallet containing product units of multiple product types.

For example, the computer system can: access an image of an inventory structure containing the partial pallet; detect a first set of objects – corresponding to a first set of product units – in a first region of the image corresponding to a first section of the partial pallet; search template images in the template image database to identify a first set of template images corresponding to (e.g., matching) the first set of objects depicted in the first region of the image; identify a first product type assigned to the first set of template images; and interpret presence of product units of the first product type in the first section of the partial pallet depicted in the first region of the image. Furthermore, the computer system can: detect a second set of objects – corresponding to a second set of product units – in a second region of the image corresponding to a second section of the partial pallet; search template images in the template image database to identify a second set of template images corresponding to (e.g., matching) the second set of objects depicted in the second region of the image; identify a second product type assigned to the second set of template images; and interpret presence of product units of the second product type in the second section of the partial pallet depicted in the second region of the image.

### 6.2 Stock Condition

In one variation, the computer system can predict a stock condition – such as defining a quantity of product units remaining within a particular handling unit (e.g., pallet) – for a top-stock slot detected within an inventory structure depicted in the image.

In particular, in one implementation, the computer system can: access an image of a first inventory structure captured by the robotic system while navigating through the facility; detect a first object – corresponding to a first pallet – depicted in a first region of the image; based on a first set of features extracted from the first region of the image, detect presence of enclosure wrap applied to the first pallet depicted in the first image; and, in response to detecting presence of enclosure wrap applied to the first pallet, interpret the first pallet as a full pallet. Then, the computer system can: implement the methods and techniques described above to predict a product type of product units stored within the first pallet; access a inventory record generated for the facility and specifying a set of pallets received at the facility during a preceding time period; search the inventory record for the first pallet containing product units of the first product type; and access a target quantity of product units of the product type corresponding to a full pallet. The computer system can then predict a quantity of product units of the product type – corresponding to (e.g., equivalent) the target quantity – stored within the first pallet. In this implementation, the computer system can, therefore, leverage identification of the first pallet as a full pallet – based on the presence of enclosure wrap depicted in the image – to predict the quantity of product units stored within the first pallet.

Additionally or alternatively, in another implementation, the computer system can: access an image of a first inventory structure captured by the robotic system while navigating through the facility; detect a first object – corresponding to a first pallet – depicted in a first region of the image; based on a first set of features extracted from the first region of the image, detect absence of enclosure wrap applied to the first pallet depicted in the first image; and, in response to detecting absence of enclosure wrap applied to the first pallet, interpret the first pallet as a partial pallet. Then, the computer system can: implement the methods and techniques described above to predict a product type of product units stored within the first pallet, such as based on matching of objects in the first region of the image to template images stored in the template image database; detect a quantity of facings on the first pallet and depicted in the image; access a set of fixed dimensions (e.g., length, width, depth) of the first pallet and/or of the first inventory structure; and, based on the quantity of facings and the set of fixed dimensions, predict a quantity of product units of the product type currently stored within the first pallet.

### 6.2 Empty Top-Stock Slot

In addition to detecting presence of pallets and product units at top-stock slots, the computer system can detect absence of an object (e.g., a handling unit) at a top-stock slot. In particular, the computer system can: access an image of an inventory structure captured by the robotic system; identify a region of the image corresponding to a top-stock slot within the facility; and, in response to detecting absence of any object within the region, predict an empty stock condition at the top-stock slot. Therefore, the computer system can generate a top-stock map that annotates each top-stock slot within the facility as occupied or empty, thus providing a complete inventory view of reserve stock distribution across the facility.

In one variation, the computer system can infer a product type associated with an empty top-stock slot based on a floor-stock shelf label arranged below the empty top-stock slot. For example, the computer system can: access the image of the inventory structure; detect absence of an object in a first region of the image corresponding to a first top-stock slot; detect a shelf label in a second region of the image below the first region, the second region corresponding to a floor-stock slot on the inventory structure; extract a product identifier from the shelf label; and, based on the product identifier and proximity between the first top-stock slot and the floor-stock slot, predict an out-of-stock condition for the product type associated with the shelf label at the first top-stock slot. Therefore, the computer system can leverage a spatial correlation between top-stock slots and floor-stock slots to infer expected product assignments even when no object is present at the top-stock slot.

### 6.2.1 Empty Top-Stock Slot & Searching Adjacent Slots

In one variation, the computer system can: identify absence of a handling unit corresponding to a product type within a first top-stock slot positioned above a floor-stock slot assigned to the product type; and, in response to identifying absence of the handling unit within the first top-stock slot, evaluate adjacent top-stock slots to confirm whether the product type is present within a local top-stock region.

In particular, the computer system can: access an image of a first inventory structure captured by the robotic system; detect a first floor-stock slot assigned to a first product type based on a shelf tag; and identify a first top-stock slot positioned above the first floor-stock slot. The computer system can then: detect absence of a handling unit corresponding to the first product type within the first top-stock slot based on features extracted from a region of the image corresponding to the first top-stock slot. The computer system can further: identify a set of adjacent top-stock slots positioned laterally adjacent the first top-stock slot; detect a set of handling units arranged within the set of adjacent top-stock slots; identify product types corresponding to the set of handling units arranged within the set of adjacent top-stock slots; and identify alternate product types – distinct from the first product type – associated with the set of handling units occupying the set of adjacent top-stock slots. Then, in response to absence of the first product type in the first top-stock slot and absence of the first product type in the set of adjacent top-stock slots, the computer system can: generate a restocking notification specifying placement of a handling unit – retrieved from the inventory region of the facility – corresponding to the first product type into the first top-stock slot; and transmit the restocking notification to the associate.

In one example, the computer system can: detect a first floor-stock slot assigned to a bottled water product type; identify a first top-stock slot positioned directly above the first floor-stock slot; and detect that the first top-stock slot is empty. The computer system can then: identify a second top-stock slot and a third top-stock slot adjacent the first top-stock slot; detect a first pallet corresponding to a soda product type in the second top-stock slot and a second pallet corresponding to a juice product type in the third top-stock slot; and identify absence of a pallet corresponding to the bottled water product type within the first top-stock slot and the adjacent top-stock slots. The computer system can then: generate a restocking notification instructing an associate to place a pallet corresponding to the bottled water product type into the first top-stock slot. Therefore, the computer system can ensure that top-stock storage remains aligned with floor-stock demand by verifying absence of a product type across a local top-stock region and selectively triggering corrective stocking actions responsive to absence of top-stock of a particular product type.

### 7. Top-Stock Placement Verification

In one implementation, the computer system can identify misplacement of a handling unit within a top-stock slot based on a location difference between the top-stock slot and a floor-stock slot assigned to a corresponding product type. In particular, in this implementation, the computer system can: access an image of a first inventory structure captured by the robotic system; detect a first object corresponding to a first handling unit arranged within a first top-stock slot depicted in the image; identify a first product identifier associated with the first handling unit; and, based on the first product identifier, associate the first handling unit with a first product type. The computer system can then: identify a floor-stock slot within the facility assigned to the first product type; characterize a location difference – such as characterized by a lateral distance, a quantity of shelving units between slots, and/or a difference in shelf, aisle, bay, etc. – between the top-stock slot and the floor-stock slot; and, in response to the location difference exceeding a threshold location difference, flag the first handling unit as misplaced. In response to flagging the first handling unit as misplaced, the computer system can: generate a relocation notification to relocate the first handling unit within the facility; and transmit the relocation notification to the associate.

The computer system can further: identify a set of candidate top-stock slots that are empty or partially empty and located within the threshold location difference of the first floor-stock slot; select a second top-stock slot from the set of candidate top-stock slots based on proximity to the first floor-stock slot and/or accessibility of the candidate top-stock slot; update the relocation notification to specify transfer of the first handling unit from the first top-stock slot to the second top-stock slot; and transmit the relocation notification to the associate. Therefore, the computer system can maintain alignment between top-stock slot locations and corresponding floor-stock slot locations, thereby reducing travel distance and improving efficiency of subsequent restocking operations.

### 7.1 Placement Rules: Compliant and Non-Compliant Top-Stock Slots

Generally, the computer system can leverage images captured by the robotic system to: identify whether placement of an object – detected in a top-stock slot on an inventory structure – is compliant with a set of placement rules defined for the facility; and generate corrective guidance responsive to detecting noncompliant placement of the object.

In particular, the computer system can: access an image of a first inventory structure captured by the robotic system; detect a first object arranged within a first region of the image corresponding to a first top-stock slot; extract a set of visual features from the first region of the image; access a set of placement rules defined for the facility; and evaluate placement of the first object within the first top-stock slot based on the set of visual features and the set of placement rules. Then, in response to identifying a violation of a placement rule, in the set of placement rules, the computer system can: flag the first object as exhibiting a noncompliant placement condition; generate a correction prompt specifying an adjustment to placement of the first object; and transmit the correction prompt to a computing device associated with an associate.

In one example, the computer system can detect an overhang condition in which a portion of the first object extends beyond a boundary of the first top-stock slot. In particular, the computer system can: characterize a boundary of the first object based on the set of visual features; identify a boundary of the first top-stock slot based on the inventory structure; and, in response to the boundary of the first object extending beyond the boundary of the first top-stock slot, flag the first object as exhibiting the overhang condition. In another example, the computer system can detect a stacking violation characterized by a set of boxes or product units exceeding a maximum height threshold defined for the inventory structure.

### 8. Output: Top-Stock Report

Generally, the computer system can: generate a top-stock report indicating detection of a set of pallets – each pallet containing product units of a particular product type – within the facility; and serve the top-stock report to an associate affiliated with the facility.

In particular, the computer system can generate a top-stock report indicating: detection of a set of pallets – in images captured by the robotic system – within the facility; a location of each pallet, in the set of pallets, within the facility, such as within a particular inventory structure, a particular shelf of an inventory structure, a particular slot within the particular shelf, and/or a particular region of the facility (e.g., customer-facing region, back-of-store inventory region); and a product type associated with each pallet in the set of pallets. The computer system can then serve this top-stock report to a facility associate affiliated with the facility and/or affiliated with stocking of pallets in the facility.

In one implementation, the computer system generates a top-stock map depicting locations of each pallet distributed within the facility. The computer system can annotate the top-stock map with pallet-specific information, such as a particular product type assigned to each pallet, a quantity of product units assigned to the pallet and/or remaining in the pallet, etc.

For example, for each object detected in a sequence of images captured by the robotic system, the computer system can record a location identifier specifying: an aisle identifier identifying the aisle within the facility in which the object was detected; a shelf identifier identifying a particular inventory structure and shelf tier within the aisle; and a slot index identifying a position of the object within that shelf tier. The computer system can then generate a top-stock map that: annotates each detected object at its corresponding position within a facility map of the facility; and further annotates each top-stock slot at which absence of product was detected.

Furthermore, in one variation, the computer system can append the top-stock report with a pallet type (e.g., a full pallet, a partial pallet, a homogenous pallet, a mixed pallet) predicted for the pallet. For example, the computer system can generate a top-stock report indicating: presence of a first pallet in a first slot of a top shelf of a first inventory structure in a customer-facing region of a facility; whether the first pallet is a full pallet or a partial pallet; whether the first pallet is a homogenous pallet – corresponding to a single product type – or a mixed pallet corresponding to multiple product type; and a set of product types (e.g., one or more product types) of product units assigned to and/or detected within the pallet.

Additionally or alternatively, in another variation, the computer system can append the top-stock report with a predicted quantity of product units remaining within a particular pallet. In particular, in this variation, the computer system can: implement the methods and techniques described above to predict a quantity of product units of a particular product type remaining in a partial pallet based on a number of facings of product units detected in the image captured by the robotic system; and/or implement the methods and techniques described above to predict a quantity of product units of a particular product type remaining in a full pallet – including enclosure wrap applied to the pallet – based on a target quantity of product units assigned to the pallet.

### 9. Re-Stock Top-Stock Slots

Generally, the computer system can generate re-stock notifications for a top-stock slot based on detection of a low-stock condition or an out-of-stock condition at the top-stock slot.

In particular, in one implementation, the computer system can: access an image of a first top-stock slot associated with a first product type captured by the robotic system; extract a set of visual features from a region of the image corresponding to the first top-stock slot; and estimate a stock condition – such as characterized by a quantity of product units – of the first product type within the first top-stock slot based on the set of visual features. Then, in response to the stock condition – such as corresponding to a low-stock condition or out-of-stock condition – deviating from a target stock condition defined for the first product type at the first top-stock slot, the computer system can: generate a re-stock notification specifying placement of a handling unit corresponding to the first product type into the first top-stock slot; and transmit the re-stock notification to the associate. Therefore, the computer system can reduce delays in restocking operations and increase overall inventory availability throughout the facility.

In another variation, the computer system can generate proactive restocking notifications for a top-stock slot based on sales data corresponding to a product type associated with the top-stock slot. In particular, the computer system can: access a set of sales data specifying a sales rate of a product type at a floor-stock slot within the customer region of the facility; based on the set of sales data, predict an out-of-stock condition at the floor-stock slot at a future time; and generate and transmit a restocking notification to a computing device of the associate prior to the future time. Therefore, the computer system can enable proactive replenishment of top-stock reserves before floor-stock depletion occurs, reducing the incidence of out-of-stock conditions visible to customers.

### 10. Top-Stock Placement Guidance

Generally, the computer system can leverage the top-stock map and floor-stock slot assignments to guide placement of incoming product units at appropriate top-stock slots throughout the facility.

In particular, the computer system can: generate a map depicting stock conditions of top-stock slots – including empty top-stock slots, occupied top-stock slots, partially-stocked top-stock slots, fully-stocked top stock slots, etc. – throughout the facility; receive confirmation of presence of a set of product units of a particular product type in an inventory region of the facility; and, based on the map, identify a target top-stock slot for stocking the set of product units and prompt the store associate to transfer the set of product units – such as contained within a singular handling unit – from the inventory region to the target top-stock slot.

In one variation, the computer system can trigger placement guidance in response to an incoming shipment. In particular, the computer system can: receive a shipment manifest identifying an upcoming delivery of a set of product units of a particular product type to the facility at a delivery time; and, in response to the shipment manifest indicating delivery of the product type and the delivery time falling within a threshold duration of a time at which an associated top-stock slot has an empty stock condition, generate a re-stocking notification and transmit the re-stocking notification to the associate at a time preceding the delivery time, thereby enabling the associate to stage the transfer of the incoming product units to the correct top-stock slot immediately upon arrival without additional search or planning.

### 10.1 Restocking of Top-Stock Slots Relative Floor-Stock Slots

In one implementation, the computer system can assign a first top-stock slot to a set of incoming product units of a product type based on proximity – such as characterized by a lateral distance or offset, a quantity of shelving units between slots, and/or a difference in shelf, aisle, bay, etc. – between candidate top-stock slots and a floor-stock slot assigned to the product type. In particular, the computer system can: access a top-stock map generated for a facility; identify a floor-stock slot, in a customer region of the facility, assigned to the product type; identify a set of empty top-stock slots in the top-stock map; and, for each top-stock slot in the set of empty top-stock slots, calculate a distance between the top-stock slot and the floor-stock slot. In response to a first distance – corresponding to a first top-stock slot in the set of empty top-stock slots – falling below a threshold distance, the computer system can assign the first top-stock slot to the set of incoming product units.

In one example, the computer system can: identify a first top-stock slot and a second top-stock slot in the set of empty top-stock slots within an aisle containing the floor-stock slot; calculate a first distance between the first top-stock slot and the floor-stock slot; calculate a second distance between the second top-stock slot and the floor-stock slot; and, in response to the first distance exceeding the second distance, select the second top-stock slot for stocking a handling unit of product units of the product type. The computer system can then: generate a re-stocking notification specifying placement of the handling unit in the second top-stock slot; and transmit the re-stocking notification to a computing device accessed by an associate. Therefore, the computer system can assign top-stock slots to incoming and/or received product units based on proximity to corresponding floor-stock slots, thereby reducing travel distance associated with subsequent restocking operations within the facility.

In particular, because associates typically transfer product units from a top-stock slot into a floor-stock slot directly below the top-stock slot when replenishing floor stock, the computer system can prioritize locating top-stock handling units – such as including pallets, boxes, individual product units, etc. – in top-stock slots in close proximity to (or directly above) floor-stock slots associated with the same product type, thereby reducing a lateral distance an associate must travel during each restocking event. Therefore, the computer system can systematically reduce restocking labor time and physical effort moving product from top-stock slots to corresponding floor-stock slots across the facility by enforcing proximity-based top-stock assignments for each incoming and/or received product type.

In another variation, the computer system can additionally account for physical handling requirements of a product type associated with a handling unit when selecting among a set of candidate top-stock slots. For example, the computer system can selectively assign top-stock slots at lower heights (e.g., above the floor) to product types with heavier or bulkier handling units in order to reduce ergonomic risk during a transfer operation.

### 10.2 Batched Re-Stocking of Top-Stock Slots

In one implementation, the computer system can aggregate multiple re-stocking tasks into a single coordinated task assignment associated with a particular aisle in the facility, thereby enabling an associate to complete multiple re-stocking operations during a single traversal of an aisle (or region of the facility).

In particular, the computer system can: access a top-stock map generated for the facility; identify a first aisle within the facility; and, based on the top-stock map, identify a set of top-stock slots arranged within the first aisle exhibiting an empty stock condition or a partially-stocked condition. The computer system can then: generate a batched restocking task list specifying the set of top-stock slots, a corresponding product type for each top-stock slot, and a target quantity of product units for each top-stock slot; and transmit the batched restocking task list to a computing device accessed by an associate prior to entry of the associate into the first aisle. Therefore, the computer system can coordinate restocking activities within a localized region of the facility, thereby reducing a quantity of trips required by the associate to complete the batched restocking task list and minimizing disruption to customer traffic within the region.

In one implementation, the computer system can sequence restocking tasks within the batched restocking task list in order to minimize a total travel distance required for the associate to complete all tasks within the aisle (or region of the facility). In particular, the computer system can: access a set of position data specifying the aisle position index of each top-stock slot in the batched restocking task list; sort the set of top-stock slots by aisle position index in ascending order corresponding to a direction of travel of the associate entering the aisle; and output the sorted sequence as the batched restocking task list. The computer system can thus ensure that the associate travels through the aisle in a single direction without backtracking, while enabling the associate to address each top-stock slot in physical sequence as the associate progresses along the aisle.

In a further implementation, the computer system can generate a pre-retrieval list – in combination with the batched restocking task list – specifying all product types and quantities of product units required from the inventory region to complete the entire batched assignment. The computer system can transmit the pre-retrieval list to the computing device of the associate prior to transmitting the batched restocking task list, thereby enabling the associate to stage all required product units on a transport vehicle — such as a pallet jack, a flatbed cart, or a powered industrial vehicle — before entering the customer-facing region to complete the restocking assignment. In particular, the computer system can: identify, for each top-stock slot in the batched restocking task list, the product type and quantity of product units required to bring the top-stock slot to a target stock level; aggregate the identified product types and quantities across all top-stock slots in the batched list; and generate a consolidated pre-retrieval list specifying each product type and its corresponding required quantity. In one variation, the computer system can account for physical constraints of available transport equipment — such as maximum weight capacity or platform dimensions of the available transport vehicle — and segment the pre-retrieval list and batched restocking task list into multiple sequential sub-batches if the total volume or weight of required product units exceeds those physical constraints, thereby enabling the associate to complete the full assignment across a minimum number of transport trips. For example, if the aggregate weight of product units required for a batched assignment across a first aisle exceeds the weight capacity of the available transport vehicle, the computer system can split the assignment into a set of subordinate user-batches – including a first sub-batch addressing the first half of the aisle and a second sub-batch addressing the second half of the aisle – each sub-batch sized within the transport vehicle’s weight capacity.

In one variation, the computer system can update the batched restocking task list in real time as the associate progresses through the assignment. In particular, as the associate completes restocking of individual top-stock slots within the batched re-stocking list, the computer system can: receive a completion confirmation transmitted from the computing device of the associate upon completion of each individual restocking task; update the top-stock map to reflect a completed restock task at a particular top-stock slot; and remove the particular top-stock slot from the (active) batched restocking task list.

### 11. Product Transfer from Top-Stock Slot to Floor Stock Slot

In one implementation, the computer system can prompt the associate to transfer product units of a product type from a top-stock slot to a floor-stock slot based on detection of an out-of-stock condition at the floor-stock slot.

In particular, in this implementation, the computer system can: access an image of a first floor-stock slot assigned to a first product type; detect absence of product units of the first product type in the first floor-stock slot; and interpret an out-of-stock condition at the first floor-stock slot. The computer system can then: identify a first top-stock slot assigned to the first product type, such as by a recent top-stock map generated for the facility; and, in response to the out-of-stock condition at the first floor-stock slot and in response to presence of a pallet – loaded with product units of the first product type – in the first top-stock slot, generate a prompt to transfer a quantity of product units of the first product type from the first top-stock slot to the first floor-stock slot. The computer system can further transmit the prompt to a computing device accessed by an associate within the facility. Therefore, the computer system can enable timely replenishment of floor-stock inventory by directing transfer of product units from proximate top-stock slots.

In one example, the computer system can: access an image of a beverage aisle depicting a first floor-stock slot assigned to a particular soda product type; detect absence of product units of the soda product type in the first floor-stock slot; and identify a first top-stock pallet containing product units of the soda product type positioned above the first floor-stock slot. The computer system can then: generate a prompt instructing an associate to retrieve a defined quantity of product units from the first top-stock pallet and place the product units into the first floor-stock slot; and transmit the prompt to a handheld computing device associated with the associate. Therefore, the computer system can reduce out-of-stock duration at the shelf by coordinating transfer of inventory from top-stock slots to corresponding floor-stock slots.

In another implementation, the computer system can prompt the associate to transfer product units of a product type from a top-stock slot to a corresponding floor-stock slot based on prediction of an out-of-stock condition at the floor-stock slot at a future time. In particular, in this implementation, the computer system can: access a set of sales data corresponding to a first product type associated with a floor-stock slot and a top-stock slot within the facility; and, based on the set of sales data, predict an out-of-stock condition for the first product type at the floor-stock slot at a first time. Then, in response to predicting the out-of-stock condition at the first time, the computer system can: generate a prompt to transfer a quantity of product units of the first product type from the top-stock slot to the floor-stock slot; and transmit the prompt to the associate at a second time preceding the first time.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method for tracking top-stock inventory throughout a facility comprising:
at a robotic system, autonomously navigating throughout regions of the facility to capture images of inventory structures, arranged throughout the facility, via an optical sensor integrated into the robotic system; and
at a computer system:
accessing a first image of a first inventory structure captured by the robotic system at a first time;
detecting a first object in a first region of the first image, the first region corresponding to a first top-stock slot within a customer region of the facility;
detecting a first product identifier depicted in the first region of the first image;
based on the first product identifier, associating the first object with a first product type;
extracting a first set of features from the first region of the first image;
based on the first set of features, predicting a first stock condition of the first product type at the first top-stock slot within the facility;
accessing a first floor-stock slot associated with the first product type in the customer region of the facility;
characterizing a location difference between the first floor-stock slot and the first top-stock slot;
in response to the location difference falling below a threshold location difference and in response to the first stock condition corresponding to a target stock condition defined for the first product type, verifying stocking of the first product type in the customer region of the facility;
accessing a second image of a second inventory structure captured by the robotic system at a second time;
detecting absence of an object in a second region of the second image, the second region corresponding to a second top-stock slot within the facility;
generating a top-stock report specifying:
the first stock condition of the first product type at the first top-stock slot; and
absence of product stock at the second top-stock slot; and
transmitting the report to an associate affiliated with the facility.

2. The method of claim 1, further comprising:
accessing a third image of the first inventory structure captured by the robotic system at a third time;
detecting a second product identifier depicted in a second region of the third image, the second region corresponding to the first floor-stock slot;
based on the second product identifier, associating the first floor-stock slot with the first product type;
extracting a set of visual features from the second region of the third image;
estimating a quantity of product units of the first product type present in the first floor-stock slot based on the set of visual features; and
in response to the quantity of product units falling below a threshold quantity defined for the first floor-stock slot:
generating a restocking notification specifying transfer of a quantity of product units of the first product type from the first top-stock slot to the first floor-stock slot; and
transmitting the restocking notification to the associate.

3. The method of claim 1:
further comprising:
detecting a second product identifier depicted in a third region of the second image, the third region below the second region and corresponding to a second floor-stock slot within the facility; and
based on proximity between the second top-stock slot and the second floor-stock slot, predicting an out-of-stock condition for the second product type at the second top-stock slot; and
wherein generating the report specifying absence of product stock at the second top-stock slot comprises generating the report specifying the out-of-stock condition of the second product type at the second top-stock slot.

4. The method of claim 3, further comprising, in response to predicting the out-of-stock condition for the second product type at the second top-stock slot:
detecting a second object in a third region of the second image depicting the second inventory structure, the third region corresponding to a third top-stock slot, adjacent the second top-stock slot, within the customer region of the facility;
detecting a second product identifier depicted in the third region of the second image;
based on the second product identifier, associating the second object with a third product type different from the second product type;
detecting a third object in a fourth region of the second image depicting the second inventory structure, the fourth region corresponding to a fourth top-stock slot, adjacent the second top-stock slot, within the customer region of the facility;
detecting a third product identifier depicted in the fourth region of the second image;
based on the third product identifier, associating the third object with a fourth product type different from the second product type; and
in response to detecting absence of the second product type in the second top-stock slot, the third top-stock slot, and the fourth top-stock slot:
querying an inventory record for a first inventory location associated with inventory of the second product type, the first inventory location located in the inventory region of the facility;
generating a prompt to transfer a set of product units of the second product type from the first inventory location to the second top-stock slot; and
transmitting the prompt to the associate.

5. The method of claim 1, wherein autonomously navigating throughout the regions of the facility to capture images of inventory structure via the optical sensor comprises, at the robotic system, traversing a first pathway extending along a first side of an aisle adjacent a second inventory structure with the optical sensor oriented toward a second side of the aisle, opposite the first side, to capture the first image of the first inventory structure adjacent the second side of the aisle.

6. The method of claim 1, wherein accessing the first image captured by the robotic system comprises:
accessing a first raw image captured by the robotic system at the first time;
accessing a set of capture data associated with the first raw image, the set of capture data comprising a first height of the optical sensor integrated within the robotic system and a second height of the first object at the first top-stock slot; and
based on the set of capture data and the first raw image, generating the first image depicting the first inventory structure from a viewing position at the second height of the first object.

7. The method of claim 1, wherein predicting the first stock condition of the first product type at the first top-stock slot based on the first set of features comprises:
based on the first set of features, detecting presence of enclosure wrap applied to the first object in the first region of the first image; and
in response to detecting presence of enclosure wrap, predicting a fully-stocked condition.

8. The method of claim 1, wherein detecting the first product identifier depicted in the first region of the first image comprises detecting the first product identifier depicted in the first region of the first image, the first product identifier comprising a SKU printed on a shelf label affixed to the first inventory structure below the first top-stock slot.

9. The method of claim 1, wherein detecting the first product identifier depicted in the first region of the first image comprises detecting the first product identifier depicted in the first region of the first image, the first product identifier printed on a surface of the first object.

10. The method of claim 1, further comprising,
detecting a third object in a third region of the first image, the third region corresponding to a third top-stock slot within the customer region of the facility;
detecting absence of a product identifier depicted in the third region of the first image; and
in response to detecting absence of the product identifier in the third region:
accessing an inventory record specifying a set of handling units received at the facility during a preceding time period, each handling unit, in the set of handling units, associated with a product type in a set of product type;
extracting a second set of features from the third region of the first image; and
based on the second set of features, the first time, the third top-stock slot, and the inventory record, associating the third object with a second product type in the set of product types.

11. The method of claim 1:
wherein predicting the first stock condition of the first product type based on the first set of features comprises predicting the first stock condition of the first product as a partially-stocked condition based on the first set of features; and
further comprising, in response to predicting the first stock condition as the partially stocked condition:
identifying a count of product facings of the first product type depicted in the first region of the first image;
accessing a set of dimensions of the first object; and
predicting a quantity of product units of the first product type at the first top-stock slot based on the count of product facings and the set of dimensions.

12. The method of claim 1, further comprising:
accessing an inventory record specifying presence of a set of handling units loaded with product units of a second product type;
identifying a second floor-stock slot, in the customer region of the facility, assigned to the second product type;
characterizing a second location difference between the second floor-stock slot and the second top-stock slot; and
in response to the second location difference falling below a second threshold difference defined for the second product type:
assigning the second top-stock slot to the second product type;
generating a prompt to transfer a handling unit, in the set of handling units, from the inventory region to the second top-stock slot, the handling unit loaded with a quantity of product units of the second product type; and
transmitting the prompt to the associate.

13. The method of claim 1:
further comprising:
accessing a third image of a third inventory structure captured by the robotic system at a third time;
detecting a third object in a third region of the third image, the third region corresponding to a third top-stock slot within the customer region of the facility;
detecting a third product identifier depicted in the third region of the third image;
based on the third product identifier, associating the third object with a third product type;
extracting a third set of features from the third region of the third image; and
based on the third set of features, predicting a third stock condition of the third product type at the third top-stock slot within the facility;
wherein generating the top-stock report comprises generating the top-stock report specifying:
the first stock condition of the first product type at the first top-stock slot;
absence of product stock at the second top-stock slot; and
the third stock condition of the third product type at the third top-stock slot; and
further comprising:
accessing a third floor-stock slot associated with the third product type in the customer region of the facility;
calculating a third location difference between the third floor-stock slot and the third top-stock slot; and
in response to the third location difference exceeding a third threshold location difference defined for the third product type:
flagging the third object for relocation to a fourth top-stock slot falling within the third threshold difference of the third floor-stock slot;
generating a prompt to relocate the third object from the third top-stock slot to the fourth top-stock slot; and
transmitting the prompt to the associate.

14. The method of claim 1:
further comprising:
detecting a second object in a third region of the first image, the third region corresponding to a third top-stock slot within a customer region of the facility;
detecting a second product identifier depicted in the third region of the first image;
based on the second product identifier, associating the second object with a third product type;
characterizing a second boundary of the second object depicted in the third region of the first image; and
in response to the second boundary extending beyond a first boundary defined by the first inventory structure:
flagging the second object as exhibiting an overhang condition at the third top-stock slot;
generating a second prompt to adjust placement of the second object on the first inventory structure to remediate the overhang condition; and
transmitting the second prompt to the associate; and
wherein generating the top-stock report comprises generating the top-stock report specifying:
the first stock condition of the first product type at the first top-stock slot;
absence of product stock at the second top-stock slot; and
a second stock condition of the third product type at the third top-stock slot.

15. A method for tracking top-stock inventory throughout a facility comprising:
at a robotic system, autonomously navigating throughout regions of the facility to capture images of inventory structures, arranged throughout the facility, via an optical sensor integrated into the robotic system; and
at a computer system:
accessing a first image of a first inventory structure captured by the robotic system at a first time;
detecting a first object in a first region of the first image, the first region corresponding to a first top-stock slot within a customer region of the facility;
detecting a first product identifier depicted in the first region of the first image;
based on the first product identifier, associating the first object with a first product type;
accessing a second image of a second inventory structure captured by the robotic system at a second time;
detecting absence of an object in a second region of the second image, the second region corresponding to a second top-stock slot within the customer region of the facility;
generating a map depicting stock conditions of top-stock slots throughout the facility, the map depicting:
the first object associated with the first product type occupying the first top-stock slot; and
absence of product in the second top-stock slot;
receiving confirmation of presence of a set of product units of a second product type in an inventory region of the facility;
accessing a floor-stock slot, in the customer region of the facility, assigned to the second product type; and
based on the floor-stock slot:
assigning the second top-stock slot to the set of product units of the second product type;
generating a prompt to transfer the set of product units of the second product type from the inventory region to the second top-stock slot; and
transmitting the prompt to an associate affiliated with the facility.

16. The method of claim 15, wherein assigning the second top-stock slot to the set of product units of the second product type based on the floor-stock slot comprises:
estimating a distance between the second top-stock slot and the floor-stock slot; and
in response to the distance falling below a threshold distance, assigning the second top-stock slot to the set of product units of the second product type.

17. The method of claim 15:
wherein generating the map depicting stock conditions of top-stock slots throughout the facility comprises generating the map depicting:
the first object associated with the first product type occupying the first top-stock slot;
absence of product in the second top-stock slot within the second inventory structure arranged within a first aisle in the facility; and
absence of product in a third top-stock slot within a third inventory structure arranged within the first aisle in the facility;
further comprising:
receiving confirmation of presence of a second set of product units of a third product type in the inventory region of the facility;
accessing a third floor-stock slot, in the customer region of the facility, assigned to the third product type; and
based on the third floor-stock slot, assigning the third top-stock slot to the second set of product units of the third product type; and
wherein generating the prompt to transfer the set of product units of the second product type from the inventory region to the second top-stock slot further comprises generating the prompt to:
transfer the set of product units of the second product type from the inventory region to the second top-stock slot during a first time period; and
transfer the second set of product units of the third product type from the inventory region to the third top-stock slot during the first time period.

18. The method of claim 15:
wherein transmitting the prompt to the associate comprises transmitting the prompt to the associate at a third time; and
further comprising:
at a fourth time succeeding the third time, accessing a set of sales data corresponding to the second product type at the floor-stock slot;
based on the set of sales data, predicting an out-of-stock condition for the second product type at the floor-stock slot at a fifth time succeeding the fourth time; and
in response to predicting the out-of-stock condition:
generating a second prompt to transfer a quantity of product units of the second product type from the second top-stock slot to the floor-stock slot; and
transmitting the second prompt to the associate at a sixth time preceding the fifth time.

19. The method of claim 15:
wherein receiving confirmation of presence of the set of product units of the second product type in the inventory region of the facility comprises accessing a shipment manifest specifying delivery of the set of product units of the second product type to the facility at a third time succeeding the second time;
wherein generating the prompt to transfer the set of product units of the second product type from the inventory region to the second top-stock slot comprises, in response to the third time falling within a threshold duration of the second time, generating the prompt to transfer the set of product units of the second product type from the inventory region to the second top-stock slot at the third time; and
wherein transmitting the prompt to the associate comprises transmitting the prompt to the associate at a fourth time preceding the third time.

20. A method for tracking top-stock inventory throughout a facility comprising:
accessing a first image of a first inventory structure captured by a robotic system autonomously navigating throughout regions of the facility to capture images of inventory structures, arranged throughout the facility, via an optical sensor integrated into the robotic system;
detecting a first object in a first region of the first image, the first region corresponding to a first top-stock slot within the facility;
detecting a first product identifier depicted in the first region of the first image;
based on the first product identifier, associating the first object with a first product type;
based on features extracted from the first region of the first image, predicting a stock condition for the first product type in the first top-stock slot;
accessing a first floor-stock slot associated with the first product type in the customer region of the facility;
estimating a distance between the first floor-stock slot and the first top-stock slot;
in response to the distance falling below a threshold distance and in response to the first stock condition corresponding to a target stock condition defined for the first product type, verifying stocking of the first product type in the first top-stock slot within the customer region of the facility;
generating a top-stock report specifying presence of a set of product units of the first product type at the first top-stock slot; and
transmitting the top-stock report to an affiliate associated with the facility.
